(19) United States
(12) Patent Application Publication
(10) Pub. No.: US 2025/0100022 A1
(43) Pub. Date: Mar. 27, 2025

(54) CLEANING MACHINE

(71) Applicant: SUGINO MACHINE LIMITED, Namerikawa City (JP)

(72) Inventors: Hideyoshi OTANI, Namerikawa City (JP); Hiroki HAREMAKI, Namerikawa City (JP)

(21) Appl. No.: 18/818,231

(22) Filed: Aug. 28, 2024

(30) Foreign Application Priority Data
Sep. 25, 2023 (JP) 2023-159968

(51) Int. Cl. B08B 3/02

(52) U.S. Cl. CPC B08B 3/024

(57) ABSTRACT

Provided is a cleaning machine that allows a nozzle to be inserted into the internal space of the cleaning machine in a simple structure. The cleaning machine includes: a table rotatable about a table axis extending in a vertical direction; a feeder extending in a front-rear direction, the feeder movable only in the vertical direction and the front-rear direction; a nozzle head disposed on the feeder, and a nozzle including an ejection opening facing in a direction different from the table axis, the nozzle disposed on the nozzle head, the nozzle rotatable about a nozzle axis extending in the vertical direction.

### CROSS-REFERENCE TO RELATED APPLICATIONS

This application claims the benefit of priority to Japanese Patent Application No. 2023-159968, filed on Sep. 25, 2023, the entire contents of which are hereby incorporated by reference.

### BACKGROUND

### 1. Technical Field

The present invention relates to a cleaning machine.

### 2. Description of the Background

A proposed cleaning machine includes a hollow table rotation shaft that rotates about a first axis, a table fixed to the table rotation shaft and capable of installing a cleaning object, and a nozzle that rotates about a second axis parallel to the first axis for ejecting cleaning fluid in a direction different from the second axis (JP2021-191572 A, hereinafter referred to as Patent Literature 1).

### BRIEF SUMMARY

In the cleaning machine of Patent Literature 1, when the inside of the cleaning object has a space such as a hole, the nozzle cannot be inserted into the space.

An object of the present invention is to provide a cleaning machine capable of inserting a nozzle into an interior space of the cleaning machine in a simple structure.

A first aspect of the present invention provides a cleaning machine, including:
a table rotatable about a table axis extending in a vertical direction;
a feeder extending in a front-rear direction, the feeder movable only in the vertical direction and the front-rear direction;
a nozzle head disposed on the feeder; and
a nozzle including an ejection opening facing in a direction different from the table axis, the nozzle disposed on the nozzle head, the nozzle rotatable about a nozzle axis extending in the vertical direction.

The nozzle moves on a feed plane that passes through the table axis and extends in the vertical and front-rear directions. The nozzle axis passes on the feed plane.

The cleaning machine may include a moving device arranged on a frame and moves the feeder in the vertical and front-rear directions.

The nozzle head is located below an upper end of the cleaning chamber body when the moving device moves the feeder to the lower end.

The moving device may include a Y-guide disposed on the frame, a moving column disposed on the Y-guide to be guided on the Y-guide, and a Z-guide disposed on the moving column. The moving device may include a Y-feed device disposed on the frame and moves the moving column, and a Z-feed device disposed on the moving column and moves the frame. The moving column moves in the front-rear direction. The feeder is disposed on the Z-guide to be guided on the Z-guide. The feeder moves in the vertical direction.

A rear opening is located in the cleaning chamber body. The expansion cover may cover the rear opening located above the feeder.

The upper cover may be detachably disposed on the cleaning chamber body. The upper cover may be an expansion cover that covers the space between the nozzle head and the upper opening.

The cleaning fluid source may be placed outside the cleaning machine. The cleaning fluid source is, for example, a liquid pump. The cleaning fluid is primarily a liquid. The cleaning fluid is, for example, water, an aqueous cleaning liquid.

The cleaning machine according to the present invention allows the nozzle to be inserted into the internal space of the cleaning machine in a simple structure.

### BRIEF DESCRIPTION OF DRAWINGS

FIG. 1 is an elevation view of a cleaning machine according to a first embodiment.

FIG. 2 is a plan view of the cleaning machine according to the first embodiment.

FIG. 3 is a perspective view of the cleaning machine according to the first embodiment.

FIG. 4 is an enlarged view of section IV in FIG. 1.

FIG. 5 is a sectional view taken along line V-V in FIG. 2.

FIG. 6 is a plan view showing a state of cleaning workpiece outer surface by the cleaning machine according to the first embodiment.

FIG. 7 is a plan view showing a state of cleaning an inside of the workpiece by the cleaning machine according to the first embodiment.

FIG. 8 is a perspective view of the cleaning machine according to a second embodiment.

### DETAILED DESCRIPTION

### First Embodiment

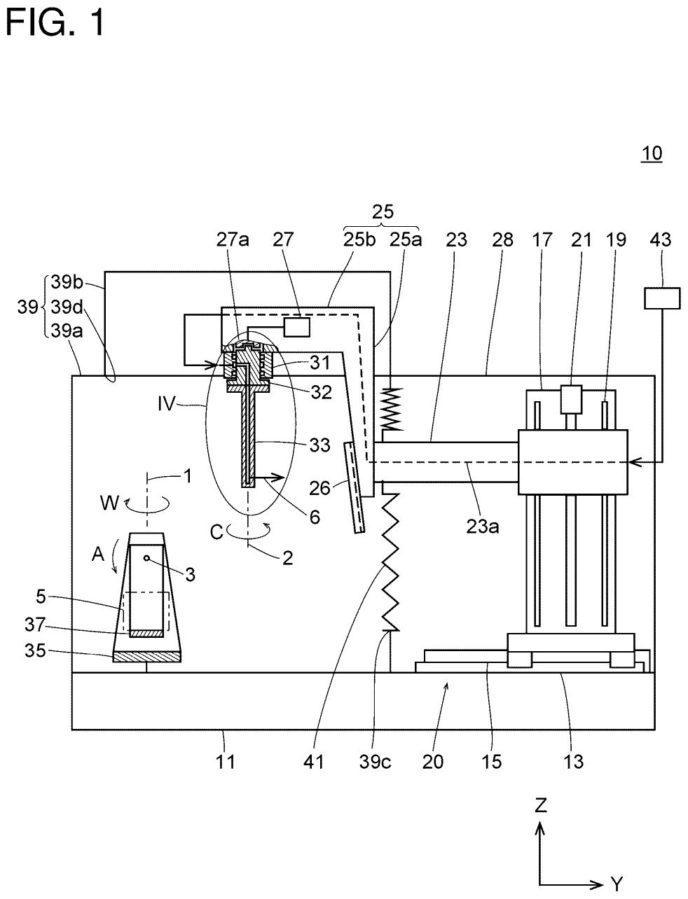

As shown in FIGS. 1 to 3, a cleaning machine 10 according to the present embodiment includes a frame 11, a moving device 20, a feeder 23, a liquid pump (cleaning fluid source) 43, a cleaning chamber 39, a machine room 28, an expansion cover 41, a nozzle head 25, a swivel housing 31, a spindle 32, a C-axis motor 27, a nozzle 33, a direct impact preventing plate 26, a table base 35, and a table 37.

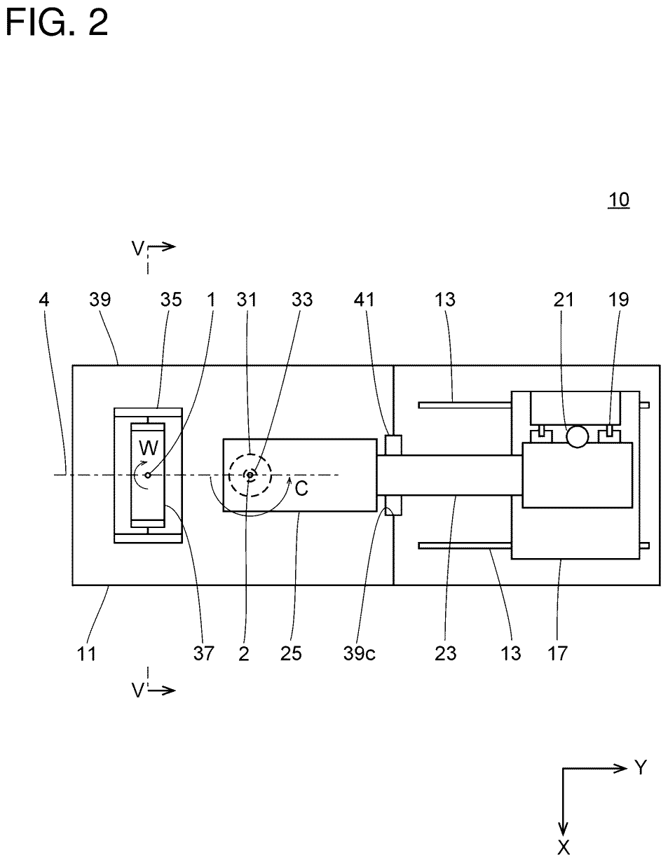

Hereinafter, a front-rear direction as viewed from a front (left side in FIG. 1) is defined as Y-axis. Further, a vertical direction is defined as Z-axis. An A-axis is a rotation direction around a pivot axis 3 extending horizontally. A C-axis is a rotation direction around a nozzle axis 2 extending vertically. A W-axis is a rotation direction around a table axis 1 extending vertically. A feed plane 4 (see FIG. 2) is a YZ plane passing through the table axis 1. The nozzle axis 2 is located on the feed plane 4.

The moving device 20 is disposed on the frame 11. The frame 11 may include a tank (not shown). The tank stores cleaning liquid (cleaning fluid). The moving device 20 includes a Y-guide (front-rear feed guide) 13, a moving column 17, a Y-feed device (front-rear feed device) 15, a Z-guide (vertical feed guide) 19, and a Z-feed device (vertical feed device) 21.

The Y-guide 13, which is disposed on a rear of the frame 11, extends in a front-rear direction. The moving column 17 is disposed on the Y-guide 13 in a movable manner in the front-rear direction. The moving column 17 is L-shaped as viewed from the front. The Z-guide 19, which extends in the vertical direction, is disposed on the moving column 17.

The Y-feed device 15 is disposed on the frame 11. The Y-feed device 15 is, for example, a ball screw and servo motor mechanism. The Y-feed device 15 moves the moving column 17 in the front-rear direction.

The liquid pump 43 may be placed outside of the cleaning machine 10. The liquid pump 43 may be connected to the tank (not shown). The liquid pump 43 pressurizes the cleaning liquid (cleaning fluid) and supplies it to the nozzle 33.

The cleaning chamber 39 includes a cleaning chamber body 39a and an upper cover 39b.

The cleaning chamber body 39a is fixed to the frame 11. The cleaning chamber body 39a has a rear opening 39c and an upper opening 39d. The rear opening 39c, which is located on the rear surface of the cleaning chamber body 39a, extends vertically. The upper opening 39d, which is located on the upper surface of the cleaning chamber body 39a, extends in the front-rear direction.

The upper cover 39b is detachably disposed on the cleaning chamber body 39a. The upper cover 39b covers the upper opening 39d. The upper cover 39b is integral with the cleaning chamber body 39a to cover the nozzle 33.

The machine room 28, which is disposed on the frame 11, covers the moving device 20. The machine room 28 may be connected to the cleaning chamber body 39a. The machine room 28 has substantially the same height as the cleaning chamber body 39a.

The feeder 23, which is disposed on the Z-guide 19, moves in the vertical direction. The cross-section of the feeder 23 is, for example, circular, diamond, or rectangular. The feeder 23 penetrates the rear opening 39c. The feeder 23 has a feeder channel 23a. The feeder channel 23a passes through the feeder 23 and the nozzle head 25. The feeder channel 23a is connected to the liquid pump 43.

The Z-feed device 21 is disposed on the moving column 17. The Z-feed device 21 is, for example, a ball screw and servo motor mechanism. The Z-feed device 21 moves the feeder 23 in the vertical direction.

The nozzle head 25 is L-shaped in a side view. The nozzle head 25 includes a column 25a and a beam 25b. The column 25a is disposed at the front end of the feeder 23. The column 25a extends upward from the feeder 23. The column 25a may have a front surface inclined rearward and downward. The beam 25b extends forward from an upper end of the column 25a.

The feeder 23 and the nozzle head 25 move together. When the feeder 23 is located in a lower position, an upper end of the nozzle head 25 is lower than an upper end of the cleaning chamber body 39a. As the feeder 23 moves upward, the nozzle head 25 passes through the upper opening 39d.

The expansion cover 41 may be, for example, a bellows, a telescopic cover, or a roll cover. The expansion cover 41 covers between the rear opening 39c and the feeder 23. The expansion cover 41 expands and contracts in the vertical direction.

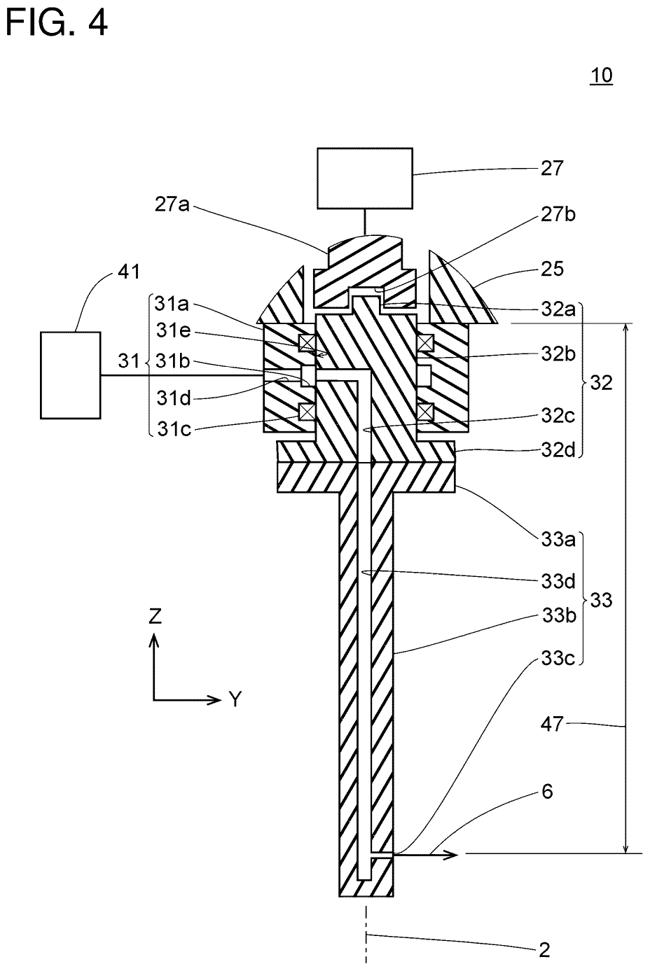

The C-axis motor 27 is located inside the nozzle head 25. As shown in FIG. 4, the C-axis motor 27 includes an output shaft 27a and a key groove 27b. The output shaft 27a extends along the nozzle axis 2 to a vicinity of a lower surface of the beam 25b. The key groove 27b is located at the lower end of the output shaft 27a.

The swivel housing 31 is disposed on the lower surface of the front end of the beam 25b. As shown in FIG. 4, the swivel housing 31 includes a body 31a, an annular channel 31b, a spindle bearing 31c, and an upper channel 31d. The body 31a extends along the nozzle axis 2. The body 31a has a cylindrical inner surface 31e. The annular channel 31b is a circumferential groove located on the inner surface 31e. The spindle bearing 31c is located at the upper and lower ends of the body 31a. The upper channel 31d penetrates the body 31a. The upper channel 31d connects the feeder channel 23a and the annular channel 31b.

The spindle 32, which is cylindrical, is supported by the spindle bearing 31c around the nozzle axis 2. The spindle 32 includes a cylindrical portion 32b, a key 32a, a spindle channel 32c, and a flange 32d. The cylindrical portion 32b slides with the inner surface 31e. The flange 32d is disposed at a lower end of the cylindrical portion 32b. The spindle channel 32c opens into the flange 32d to connect the annular channel 31b and a nozzle channel 33d. The key 32a, which is located at an upper end of the cylindrical portion 32b, engages the key groove 27b.

The nozzle 33 includes a flange 33a, a shaft 33b, an ejection opening 33c, and the nozzle channel 33d. The flange 33a is located at an upper end of the nozzle 33 to be fastened with the flange 32d. The shaft 33b extends downward from the flange 33a along the nozzle axis 2. The ejection opening 33c is disposed at a distal end portion of the shaft 33b. The ejection opening 33c has a substantially the same height as the feeder 23. For example, the ejection opening 33c ejects a jet 6 horizontally. The nozzle channel 33d opens into the flange 33a to connect the spindle channel 32c and the ejection opening 33c.

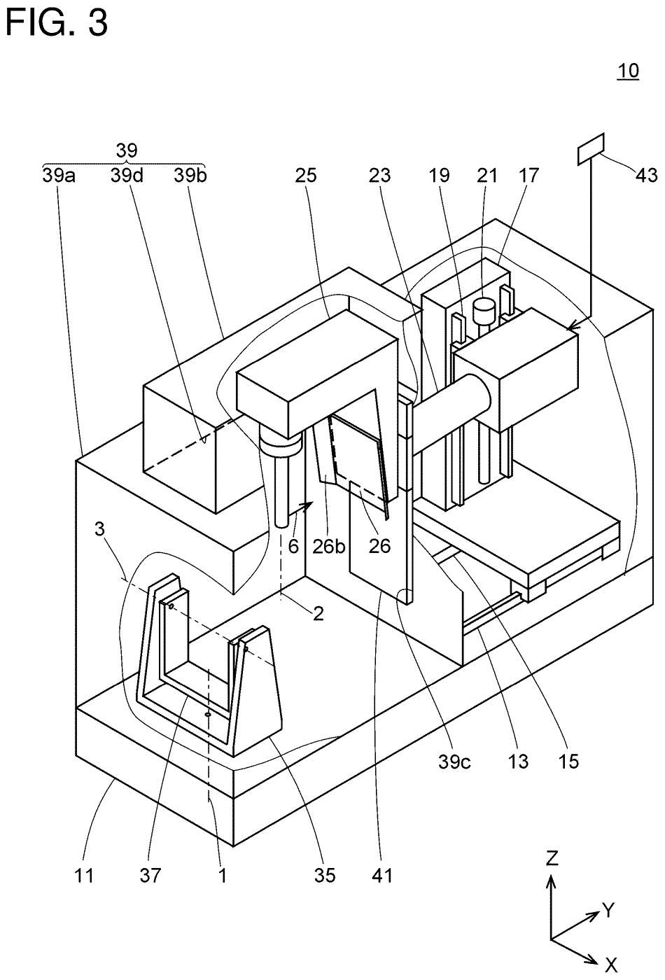

As shown in FIGS. 1 and 3, the direct impact preventing plate 26 is disposed on the front surface of the column 25a. The direct impact preventing plate 26 may have a folded portion 26b. The direct impact preventing plate 26 extends in the up-down and left-right direction. The direct impact preventing plate 26 may be inclined backward as it is directed downward. Preferably, the direct impact preventing plate 26 extends below the column 25a and the feeder 23. The folded portion 26b is disposed on the right and left sides of the direct impact preventing plate 26 as viewed from the front. The folded portion 26b is a frontward fold. When the ejection opening 33c faces rearward, the jet 6 ejected from the ejection opening 33c collides with the direct impact preventing plate 26. Preferably, the direct impact preventing plate 26 is detachably attached to the nozzle head 25.

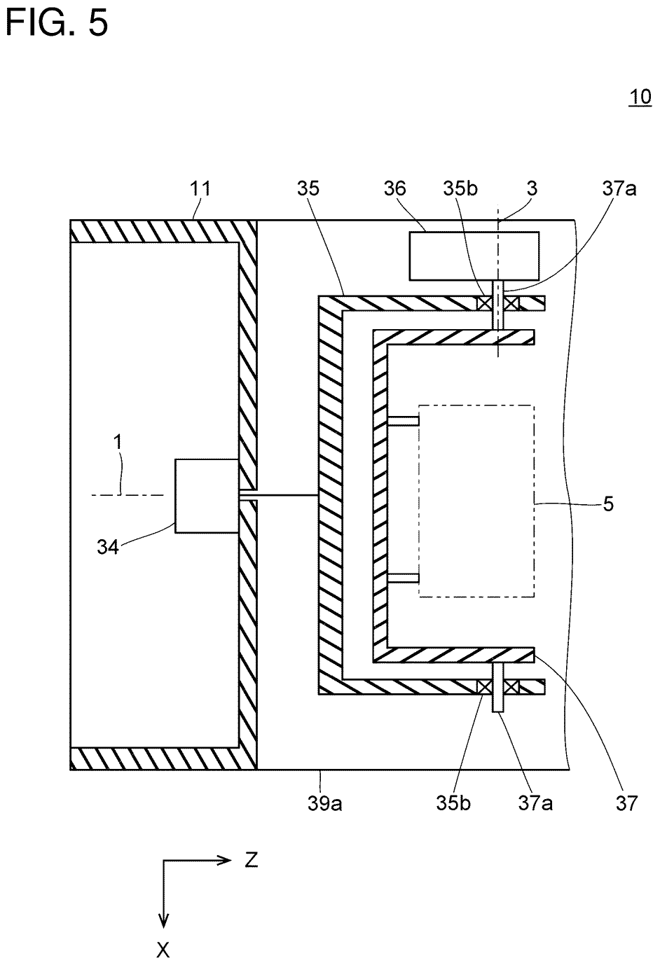

As shown in FIG. 5, the cleaning machine 10 includes a W-axis motor 34. The W-axis motor 34 is disposed on the frame 11. The W-axis motor 34 is, for example, a servo motor.

The table base 35 includes a pair of trunnion bearings 35b and a turning device 36. The table base 35 is U-shaped in a front view. In a front view, a central portion of the table base 35 extends horizontally. In a front view, the right and left ends of the table base 35 extend upward from the central portion. The table base 35 is disposed on the frame 11 to rotate about the table axis 1. The table base 35 is connected to the W-axis motor 34. The trunnion bearings 35b are disposed in an upper end of the left and right of the table base 35 with the pivot axis 3 at the center. The turning device 36 is supported on the table base 35. The turning device 36 rotates about the table axis 1 integrally with the table base 35. The turning device 36 is, for example, an air cylinder, or a servo motor.

The table 37 has a trunnion shaft 37a. The table 37 is U-shaped in a front view. In a front view, a central portion of the table 37 extends horizontally. In a front view, the left and right ends of the table 37 extends upward from the central portion. The trunnion shafts 37a are disposed at the upper ends of the left and right of the table 37. The trunnion shaft 37a is rotatably supported by the trunnion bearing 35b. The table 37 is connected to the turning device 36. For example, the table 37 can be rotated 90 degrees or 180 degrees about the pivot axis 3.

The workpiece 5 is installed on the table 37. The workpiece 5 is, for example, an E-axle case, an inverter case, and a transaxle case.

As shown in FIG. 2, the table 37 rotates about the table axis 1 integrally with the table base 35. The moving device 20 moves the nozzle 33 so that the nozzle axis 2 passes on a feed plane 4. Then, the C-axis motor 27 rotates the nozzle 33 about the nozzle axis 2.

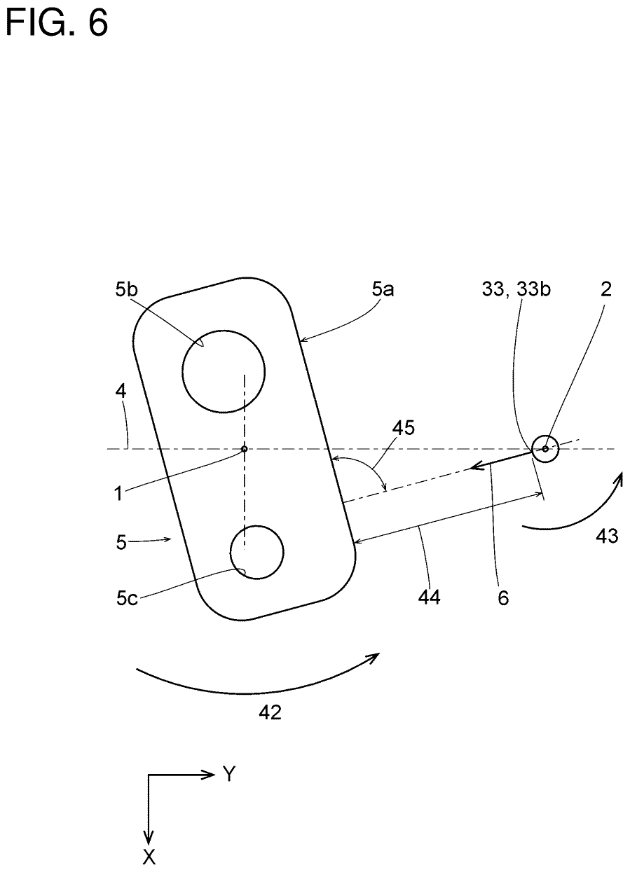

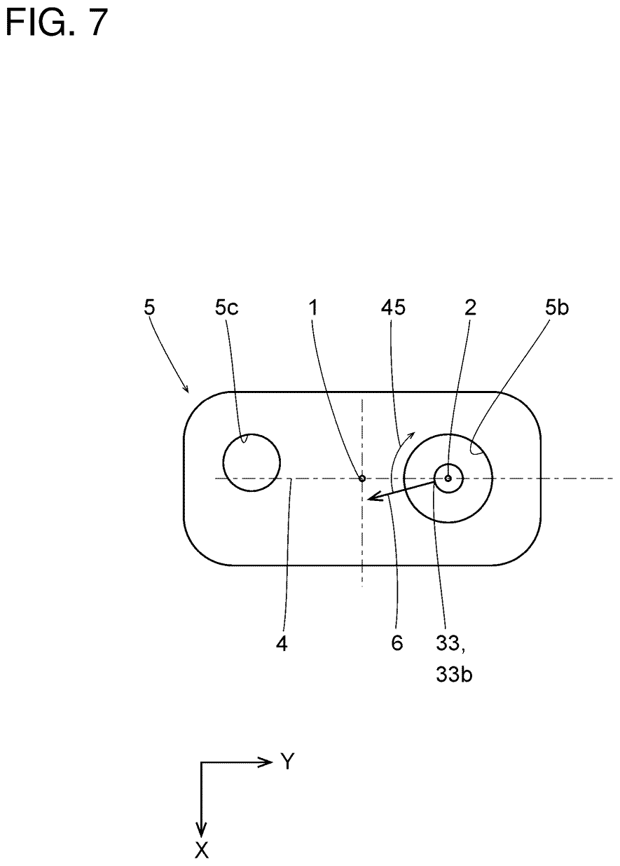

Hereinafter, a method of using the cleaning machine 10 will be described with reference to FIGS. 6 and 7.

As shown in FIG. 6, the workpiece 5 has an outer peripheral surface 5a, a shaft hole 5b, and a shaft hole 5c. The shaft hole 5b and the shaft hole 5c extend vertically to penetrate the workpiece 5. The workpiece 5 may have an oil hole extending in a radial direction from the shaft hole 5b or the shaft hole 5c inside the workpiece 5, or may have a groove extending in a circumferential direction of the shaft hole 5b and the shaft hole 5c.

When the cleaning machine 10 cleans the entire outer peripheral surface 5a, the W-axis motor 34 and the C-axis motor 27 rotate the table 37 and the nozzle 33 in synchronization so that a collision angle 45 between the outer peripheral surface 5a and the jet 6 is kept constant. The collision angle 45 is, for example, 90 degrees. At this time, the Y-feed device 15 may be controlled in synchronization with the W-axis so that a distance 44 between the nozzle 33 and the outer peripheral surface 5a is kept constant. When the outer peripheral surface 5a has a tap or a pin hole or the like (not shown), the Y-feed device 15, the Z-feed device 21, the C-axis motor 27, and the W-axis motor 34 may be controlled so that a central axis of the tap or the pin hole and the jet 6 are coaxial.

Referring to FIG. 7, the cleaning machine 10 will be described for cleaning the shaft hole 5b. First, the W-axis motor 34 rotates the table 37 so that a central axis of the shaft hole 5b is positioned on the feed plane 4. Next, above the workpiece 5, the moving device 20 controls the Y-feed device 15 and the Z-feed device 21 to align the nozzle axis 2 with the center of the shaft hole 5b. The Z-feed device 21 then lowers the nozzle 33 along the Z-axis into the inside of the workpiece 5. The nozzle 33 ejects the jet 6, and the C-axis motor 27 rotates the nozzle 33. When the cleaning of the shaft hole 5b is completed, the Z-feed device 21 moves the nozzle 33 upward above the workpiece 5.

The cleaning machine 10 according to the present embodiment allows the outer peripheral surface 5a of the workpiece 5 and the cavity inside the shaft hole 5b or the shaft hole 5c to be cleaned. Further, by turning device 36 swivels the workpiece 5, the upper surface and lower surface of the workpiece 5 can also be cleaned. The cleaning includes deburring using a high-pressure jet.

As shown in FIG. 7, when the nozzle 33 is inserted into the inside of the workpiece 5, the nozzle 33 once passes over the workpiece 5 for inserting the nozzle 33 into the inside of the workpiece 5. A length 47 from the nozzle head 25 to the ejection opening 33c (see FIG. 4) is longer than an insertion depth of the nozzle 33 into the workpiece 5. When the nozzle 33 passes over the workpiece 5, the nozzle head 25 moves upward.

The nozzle head 25 in the embodiment is L-shaped. The nozzle 33 extends downward from a distal end portion of the nozzle head 25. The nozzle 33 is inserted into the workpiece 5 so that the nozzle head 25 and the nozzle 33 wrap around the workpiece 5 from above. By moving the feeder 23 upward to a height substantially the same as the upper surface of the workpiece 5, the nozzle 33 can pass over the workpiece 5. This suppresses the maximum height of the feeder 23. This also suppresses the height of the moving column 17 and the machine room 28. When the assembly height of heavy objects is high, the height of the assembly area is required. Suppressing the height reduces the constraint of the assembly factory.

The cleaning chamber body 39a has the upper opening 39d. The upper cover 39b covers the upper opening 39d. When the feeder 23 is at the upper end, the nozzle head 25 passes through the upper opening 39d. Only the upper cover 39b thus protrudes upward from the cleaning chamber body 39a and the machine room 28.

By lowering the height of the cleaning chamber 39 and the machine room 28 that occupy the majority of the cleaning machine 10, factory pipes, conveyors, the factory-side cable protective pipe or the like can pass the space around (front, rear, left, and right) the upper cover 39b. Also, as most of the cleaning machine 10 can be constructed at a low height, the prospect of the factory where the cleaning machine 10 is installed is improved.

The upper cover 39b is detachable with the feeder 23 being lowered so that the nozzle head 25 is located below the upper end of the cleaning chamber body 39a. When the cleaning machine 10 is transported in this state, the height of the cleaning machine 10 during transport can be suppressed. This allows the cleaning machine 10 onto containers or trucks easily. Further, the cleaning machine 10 easily passes through a loading port to be easily carried in.

The table 37 is rotated around the table axis 1, and the nozzle 33 moves only in the front-rear and vertical directions. This allows a machine width of the cleaning machine to be narrow even if the workpiece 5 is large. This also reduces the installation area of the cleaning machine.

As the lower portion of the direct impact preventing plate 26 is inclined rearward, the jet collided with the direct impact preventing plate 26 changes the flow along the direct impact preventing plate 26 to proceed downward. This suppress the damage to the nozzle head 25 and the upper cover 39b due to the bouncing jet. Further, as the jet 6 ejected rearward from the ejection opening 33c collides with the direct impact preventing plate 26, the damage to the expansion cover 41 is suppressed.

### Second Embodiment

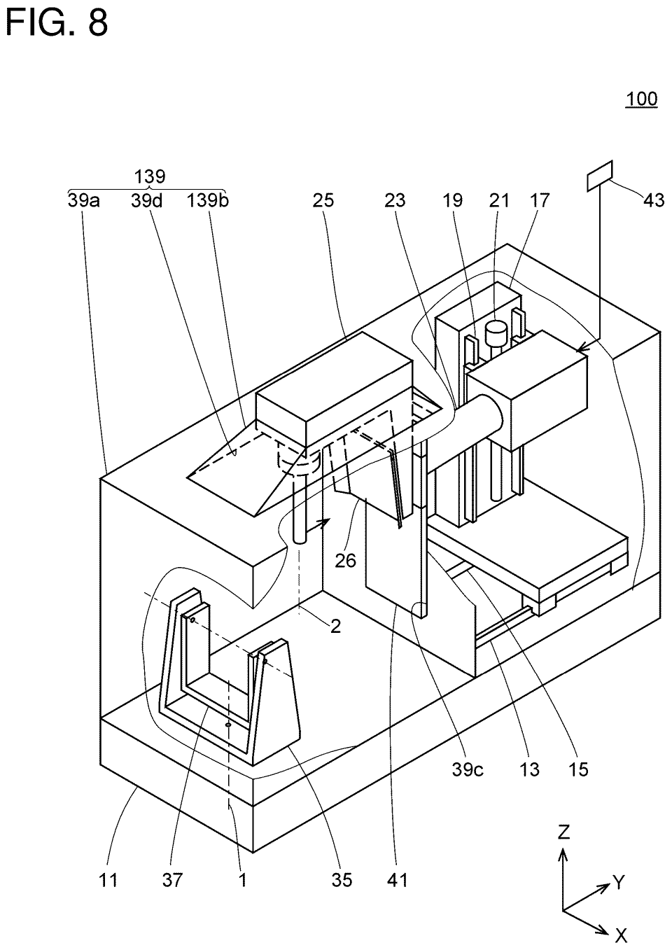

As shown in FIG. 8, a cleaning machine 100 according to the present embodiment includes a cleaning chamber 139. Other configurations of cleaning machine 100 according to the present embodiment are substantially identical to the cleaning machine 10 of the first embodiment.

The cleaning chamber 139 includes a cleaning chamber body 39a, a rear opening 39c, an upper opening 39d, and an upper cover 139b. The upper cover 139b is an expansion cover. The upper cover 139b is, for example, a bellows, a telescopic cover, or a roll cover. The upper cover 139b covers between the upper opening 39d and the nozzle head 25.

In the cleaning machine 100 according to the present embodiment, by lowering the feeder 23, the device height is lowered without detaching the upper cover 139b.

### REFERENCE SIGNS LIST

1 Table axis
2 Nozzle axis
10, 100 Cleaning machine
23 Feeder
25 Nozzle head
33 Nozzle
33c Ejection opening
37 Table

What is claimed is:

1. A cleaning machine, comprising:
a table rotatable about a table axis extending in a vertical direction;
a feeder extending in a front-rear direction, the feeder movable only in the vertical direction and the front-rear direction;
a nozzle head disposed on the feeder; and
a nozzle including an ejection opening facing in a direction different from the table axis, the nozzle disposed on the nozzle head, the nozzle rotatable about a nozzle axis extending in the vertical direction.

2. The cleaning machine according to claim 1, wherein
the nozzle head includes,
a column extending upward from the feeder, and
a beam extending frontward from an upper end of the column, and
the nozzle is disposed at a distal end portion of the beam.

3. The cleaning machine according to claim 1, wherein
the nozzle includes a shaft extending downward along the nozzle axis, and
the ejection opening is located in a lower end portion of the shaft and is directed in a horizontal direction.

4. The cleaning machine according to claim 1, further comprising:
a frame supporting the table;
a moving device disposed on the frame to move the feeder in the vertical direction and the front-rear direction; and
a cleaning chamber surrounding the nozzle, the cleaning chamber including,
a cleaning chamber body having an upper opening, the cleaning chamber body fixed to the frame, and
an upper cover covering the upper opening;
wherein
when the moving device moves the feeder to a lower end, the nozzle head is positioned lower than an upper end of the cleaning chamber body, and
when the moving device moves the feeder upward, the nozzle head passes through the upper opening.

5. The cleaning machine according to claim 4, wherein
the cleaning chamber has a rear opening extending in the vertical direction for the feeder to pass through,
the cleaning machine further comprising:
a direct impact preventing plate disposed frontward of the column, the direct impact preventing plate extending in the vertical direction so as to be inclined rearward and downward; and
an expansion cover configured to cover the rear opening located downward of the feeder, the expansion cover configured to expand and contract in the vertical direction.

6. The cleaning machine according to claim 1, further comprising:
a cleaning fluid source configured to supply cleaning fluid to the nozzle;
a swivel housing connected to the cleaning fluid source, the swivel housing disposed on the nozzle head; and
a spindle supported by the swivel housing in a rotatable manner about the nozzle axis, the spindle including a spindle channel connecting the nozzle and the cleaning fluid source, the spindle supporting the nozzle.

7. The cleaning machine according to claim 1, further comprising:
a table base including a trunnion bearing, the table base rotatable about the table axis,
wherein the table includes a trunnion shaft extending in the horizontal direction and rotatably supported by the trunnion bearing, and the table is rotatable about the trunnion shaft.

8. The cleaning machine according to claim 2, wherein
the nozzle includes a shaft extending downward along the nozzle axis, and
the ejection opening is located in a lower end portion of the shaft and is directed in a horizontal direction.

9. The cleaning machine according to claim 2, further comprising:
a frame supporting the table;
a moving device disposed on the frame to move the feeder in the vertical direction and the front-rear direction; and
a cleaning chamber surrounding the nozzle, the cleaning chamber including,
a cleaning chamber body having an upper opening, the cleaning chamber body fixed to the frame, and
an upper cover covering the upper opening;
wherein
when the moving device moves the feeder to a lower end, the nozzle head is positioned lower than an upper end of the cleaning chamber body, and
when the moving device moves the feeder upward, the nozzle head passes through the upper opening.

10. The cleaning machine according to claim 3, further comprising:
a frame supporting the table;
a moving device disposed on the frame to move the feeder in the vertical direction and the front-rear direction; and
a cleaning chamber surrounding the nozzle, the cleaning chamber including,
a cleaning chamber body having an upper opening, the cleaning chamber body fixed to the frame, and
an upper cover covering the upper opening;
wherein
when the moving device moves the feeder to a lower end, the nozzle head is positioned lower than an upper end of the cleaning chamber body, and
when the moving device moves the feeder upward, the nozzle head passes through the upper opening.

11. The cleaning machine according to claim 2, further comprising:
a cleaning fluid source configured to supply cleaning fluid to the nozzle;
a swivel housing connected to the cleaning fluid source, the swivel housing disposed on the nozzle head; and
a spindle supported by the swivel housing in a rotatable manner about the nozzle axis, the spindle including a spindle channel connecting the nozzle and the cleaning fluid source, the spindle supporting the nozzle.

12. The cleaning machine according to claim 3, further comprising:
a cleaning fluid source configured to supply cleaning fluid to the nozzle;
a swivel housing connected to the cleaning fluid source, the swivel housing disposed on the nozzle head; and
a spindle supported by the swivel housing in a rotatable manner about the nozzle axis, the spindle including a spindle channel connecting the nozzle and the cleaning fluid source, the spindle supporting the nozzle.

13. The cleaning machine according to claim 4, further comprising:
a cleaning fluid source configured to supply cleaning fluid to the nozzle;
a swivel housing connected to the cleaning fluid source, the swivel housing disposed on the nozzle head; and
a spindle supported by the swivel housing in a rotatable manner about the nozzle axis, the spindle including a spindle channel connecting the nozzle and the cleaning fluid source, the spindle supporting the nozzle.

14. The cleaning machine according to claim 5, further comprising:
a cleaning fluid source configured to supply cleaning fluid to the nozzle;
a swivel housing connected to the cleaning fluid source, the swivel housing disposed on the nozzle head; and
a spindle supported by the swivel housing in a rotatable manner about the nozzle axis, the spindle including a spindle channel connecting the nozzle and the cleaning fluid source, the spindle supporting the nozzle.

15. The cleaning machine according to claim 2, further comprising:
a table base including a trunnion bearing, the table base rotatable about the table axis,
wherein the table includes a trunnion shaft extending in the horizontal direction and rotatably supported by the trunnion bearing, and the table is rotatable about the trunnion shaft.

16. The cleaning machine according to claim 3, further comprising:
a table base including a trunnion bearing, the table base rotatable about the table axis,
wherein the table includes a trunnion shaft extending in the horizontal direction and rotatably supported by the trunnion bearing, and the table is rotatable about the trunnion shaft.

17. The cleaning machine according to claim 4, further comprising:
a table base including a trunnion bearing, the table base rotatable about the table axis,
wherein the table includes a trunnion shaft extending in the horizontal direction and rotatably supported by the trunnion bearing, and the table is rotatable about the trunnion shaft.

18. The cleaning machine according to claim 5, further comprising:
a table base including a trunnion bearing, the table base rotatable about the table axis,
wherein the table includes a trunnion shaft extending in the horizontal direction and rotatably supported by the trunnion bearing, and the table is rotatable about the trunnion shaft.

19. The cleaning machine according to claim 6, further comprising:
a table base including a trunnion bearing, the table base rotatable about the table axis,
wherein the table includes a trunnion shaft extending in the horizontal direction and rotatably supported by the trunnion bearing, and the table is rotatable about the trunnion shaft.
